(19) United States
(12) Patent Application Publication
(10) Pub. No.: US 2022/0176778 A1
(43) Pub. Date: Jun. 9, 2022

(54) ADAPTIVE AND PREDICTIVE CLIMATE CONTROL SYSTEM USING INFRARED IMAGE-BASED IMAGING

(71) Applicant: Lear Corporation, Southfield, MI (US)

(72) Inventors: Francesco Migneco, Saline, MI (US); David Gallagher, Sterling Heights, MI (US); Patricia Donnelly, Beavercreek, OH (US)

(73) Assignee: Lear Corporation, Southfield, MI (US)

(21) Appl. No.: 17/113,667

(22) Filed: Dec. 7, 2020

(51) Int. Cl. B60H 1/00; G01J 5/00

(52) U.S. Cl. CPC B60H 1/00742; H04N 5/33; G01J 5/0025

(57) ABSTRACT

A vehicle climate control system uses infrared image-based measurements of an occupant of a vehicle seat and other environmental information to adaptively and predictively generate the heating, cooling, and/or ventilating effects. An infrared image-based sensor senses data regarding an occupant of the vehicle seat. An apparatus generates heating, cooling, and/or ventilating effects in and/or around the seat. A controller is responsive to the data from the infrared image-based sensor for controlling the operation of the apparatus for generating heating, cooling, and/or ventilating effects. Depending upon the amount of data that has been received by the controller, the apparatus for generating heating, cooling, and/or ventilating effects is operated in either a standard mode, an adaptive mode, or a predictive mode.

### BACKGROUND OF THE INVENTION

This invention relates in general to climate control systems that generate heating, cooling, and/or ventilating effects. In particular, this invention relates to an improved structure for a vehicle climate control system that uses infrared image-based imaging of an occupant of a vehicle seat and other environmental information to adaptively and predictively generate the heating, cooling, and/or ventilating effects within the vehicle.

Most vehicles include one or more seats for supporting respective occupants thereon. A typical vehicle seat includes a seat bottom portion and a seat back portion, each of which has a structural frame having supporting and cushioning features provided thereon. Each of the structural frames is typically formed from a relatively rigid material, such as steel or aluminum. The supporting and cushioning features typically include one or more springs supported on the structural frame, a foam bun supported on the springs, and an external trim or upholstery layer supported on the foam bun. These features make the seat bottom portion and the seat back portion of the seat comfortable for the occupant and provide the seat with an aesthetically pleasing appearance.

Most vehicles also include a climate control system that generates heating, cooling, and/or ventilating effects in or about the seat for the comfort of the occupant supported thereon. A typical heating system for a vehicle seat may, for example, include a source of electrical energy that is selectively connected to a heating mat provided within the vehicle seat. When the source of electrical energy is energized, electrical current flows through an electrically conductive wire contained in the heating mat. Because of its inherent resistance to the flow of electrical current therethrough, the electrically conductive wire generates heat, which is then radiated through the heating mat and the vehicle seat to the body of the occupant. A typical cooling system for a vehicle seat may, for example, include a thermoelectric device that creates a temperature differential between two sides thereof when a voltage is applied across the device. This causes heat to be drawn away from the surface of the vehicle seat (and, thus, away from the body of the occupant) and conducted therefrom by air or fluid flow. A typical ventilating system for a vehicle seat may, for example, include a fan that is selectively energized to move air through one or more passageways provided in the vehicle seat. When the fan is energized, the air moving through the passageways removes heat from the body of the occupant sitting on the vehicle seat.

In conventional vehicle climate control systems, the operations of the heating, cooling, and/or ventilating effects are controlled by the occupant of the vehicle seat using manually operable control devices, such as manipulating push buttons and rotatable knobs, for example. Although these conventional heating, cooling, and/or ventilating systems have been effective, it would be desirable to provide an improved structure for such a climate control system that uses infrared image-based imaging and/or other measurements of an occupant of a vehicle seat and other environmental information to adaptively and predictively generate the heating, cooling, and/or ventilating effects.

### SUMMARY OF THE INVENTION

This invention relates to an improved structure for a vehicle climate control system that uses infrared image-based imaging and/or other measurements of an occupant of a vehicle seat and other environmental information to adaptively and predictively generate heating, cooling, and/or ventilating effects. The climate control system includes an infrared image-based sensor that is adapted to sense or otherwise determine data regarding an occupant of a seat. The climate control system also includes an apparatus for generating heating, cooling, and/or ventilating effects in and/or around the seat. Lastly, the climate system includes a controller that is responsive to the data from the infrared image-based sensor for controlling the operation of the apparatus for generating the heating, cooling, and/or ventilating effects. The controller normally controls the operation of the apparatus for generating the heating, cooling, and/or ventilating effects in a standard mode. However, when a first amount of data has been received by the controller, the controller controls the operation of the apparatus for generating the heating, cooling, and/or ventilating effects in an adaptive mode. Alternatively, when a second amount of data has been received by the controller, the controller controls the operation of the apparatus for generating the heating, cooling, and/or ventilating effects in a predictive mode.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a schematic view of a portion of a vehicle including a climate control system that uses infrared image-based imaging and/or other measurements of an occupant of a vehicle seat and other environmental information to adaptively and predictively generate heating, cooling, and/or ventilating effects in accordance with this invention.

FIG. 2 is a block diagram of the vehicle climate control system illustrated in FIG. 1.

FIG. 3 is a flowchart that shows the operation of the vehicle climate control system illustrated in FIGS. 1 and 2.

### DETAILED DESCRIPTION OF THE PREFERRED EMBODIMENT

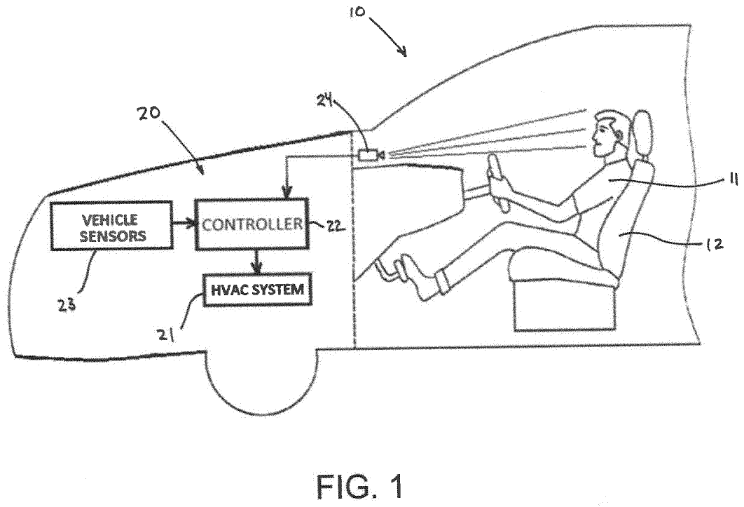

Referring now to the drawings, there is illustrated in FIG. 1 a schematic view of a portion of a vehicle, indicated generally at 10, that includes a climate control system, indicated generally at 20, in accordance with this invention. As will be explained in detail below, the illustrated climate control system 20 receives infrared image-based images and/or other measurements of an occupant 11 of a vehicle seat 12 and other environmental information from within and about the vehicle 10 and uses such images and/or other measurements and information to adaptively and predictively operate the climate control system 20 to generate heating, cooling, and/or ventilating effects for the comfort of the occupant 11 within the vehicle 10.

The illustrated vehicle 10 is, of itself, conventional in the art and is intended merely to illustrate one environment in which this invention may be used. Thus, the scope of this invention is not intended to be limited for use with the specific structure for the vehicle 10 illustrated in FIG. 1 or with vehicles in general. On the contrary, as will become apparent below, the climate control system 20 of this invention may be used in any desired environment for the purposes described below.

The illustrated climate control system 20 includes an HVAC system 21 for generating heating, ventilating, and/or cooling effects in or about the vehicle seat 12 for the comfort of the occupant 11 within the vehicle 10. The HVAC system 21 is, of itself, conventional in the art and may include one or more conventional mechanisms (not shown) that can be selectively operated to provide the heating, ventilating, and/or cooling effects within the vehicle 10, such as described above. To accomplish this, the illustrated HVAC system 21 may be provided as a part of the original equipment of the vehicle 10. However, the HVAC system 21 may be embodied as any desired structure or combination of structures that can provide some or all of these functions, and may further be operated to provide any desired effect or combination of effects at any desired location or locations within the vehicle 10.

The illustrated climate control system 20 also includes a controller 22 for controlling the operation of the HVAC system 21. The controller 22 is, of itself, conventional in the art and may be embodied as a microprocessor or other conventional electronic data processing device. The illustrated controller 22 may, if desired, be provided as a part of the original equipment of the vehicle 10. However, the controller 22 may be embodied as any desired structure or combination of structures that can control the operation of the HVAC system 21 in the manner described below. The illustrated climate control system 20 further includes one or more vehicle condition sensors 23 and one or more occupant condition sensors 24. As will be explained in detail below, each of the vehicle condition sensors 23 is adapted to sense or otherwise determine an associated condition in and/or around the vehicle 10, while each of the occupant condition sensors 24 is adapted to sense or otherwise determine an associated condition of the occupant 11 of the vehicle seat 12.

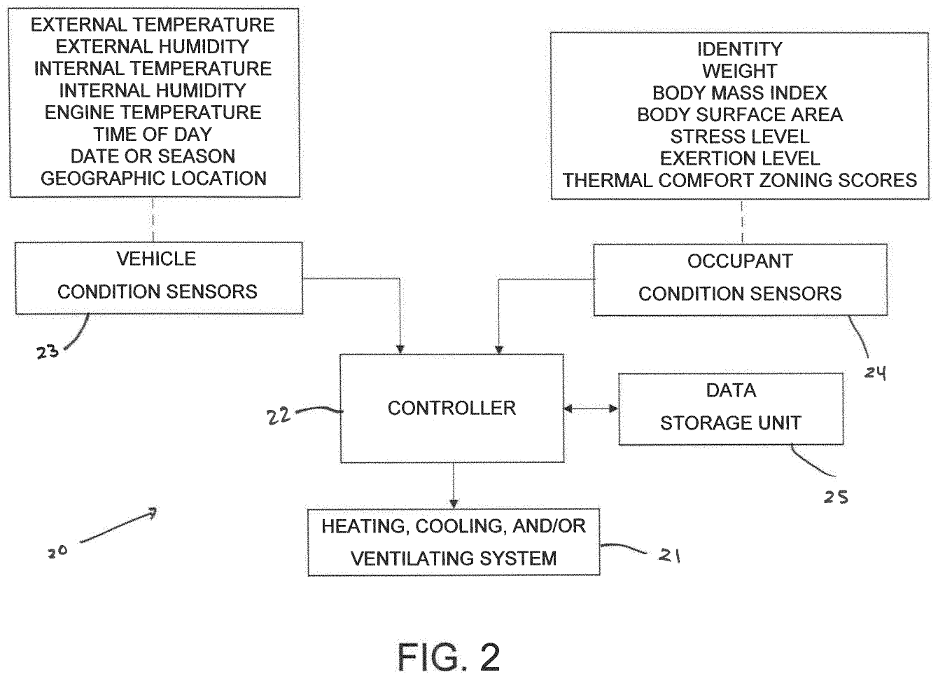

FIG. 2 is a block diagram that illustrates in more detail the structure of the climate control system 20 shown in FIG. 1. The vehicle condition sensors 23 may be used to sense or otherwise determine a variety of conditions in and/or around the vehicle 10 including, for example:

temperature outside of the vehicle;

humidity outside of the vehicle;

temperature inside of the vehicle;

humidity inside of the vehicle;

temperature of the vehicle engine;

time of day;

date or season; and

geographic location of the vehicle.

The illustrated list of conditions in and/or around the vehicle 10 is only exemplary, and this invention contemplates that a greater or lesser number of such conditions in and/or around the vehicle 10 may be sensed or otherwise determined by the vehicle condition sensors 23. Each of the vehicle condition sensors 23 may be embodied as any conventional sensing device that is adapted to generate a signal that is representative of the associated condition in or about the vehicle 10. For example, the vehicle condition sensors 23 may be embodied as conventional thermometers, humidity sensors, chronometers, and/or GPS devices.

Similarly, the occupant condition sensors 24 may be used to sense or otherwise determine a variety of conditions related to the occupant 11 of the vehicle seat 12 including, for example:

identity;

weight;

body mass index;

body surface area;

stress level;

physical exertion level; and

thermal comfort zoning score.

The illustrated list of conditions of the occupant 11 of the vehicle seat 12 is only exemplary, and this invention contemplates that a greater or lesser number of such conditions related to the occupant 11 of the vehicle seat 12 may be sensed or otherwise determined by the occupant condition sensors 24. Each of the occupant condition sensors 24 may be embodied as any conventional sensing device that is adapted to generate a signal that is representative of the associated condition of the occupant 11 of the vehicle seat 12.

For example, one or more of the occupant condition sensors 24 may be embodied as an infrared image-based sensor, such as a conventional infrared camera as shown in FIG. 1. Such an infrared camera may sample one or more areas of the face and/or other body portion(s) of the occupant 11 of the vehicle seat 12 at one or more anatomical locations to generate an assessment of the pixel intensity therein. Such an assessment may then, for example, be used to determine the level of vasodilation therein, which can provide a better correlation of thermal comfort of the occupant 11 than a conventional sensed temperature. Distributed regions of interest within an image or dataset (e.g., nose, cheeks, mouth, etc.) provide localized vasodilation statuses of the occupant 11, which can be correlated to generalized or user-specific conditions of the thermal comfort zoning scores. Monitored over time, those same regions can provide transient thermal characteristics that can be extrapolated to provide a thermal comfort trajectory and an estimated amount of time to and/or from (or intersection thereof) a specific and desired thermal comfort zone. Additionally, the same infrared camera may be used to identify the occupant 11 of the vehicle seat 12 based on specific facial landmarks and/or facial vein patterns.

Generally speaking, the controller 22 is responsive to the signals from the vehicle condition sensors 23 and the occupant condition sensors 24 for generating signals to control the operation of the HVAC system 21 in accordance with a predetermined mode or group of modes. To facilitate this, the controller 22 may include or otherwise be connected to a data storage unit 25 that stores the signals from the vehicle condition sensors 23 and the occupant condition sensors 24 on either a short-term or a long-term basis. The data storage unit 25 may also store one or more profiles and/or other data for controlling the operation of the HVAC system 21 in one or more of the modes. The specific manner in which the controller 22 controls the operation of the HVAC system 21 will be explained in detail below.

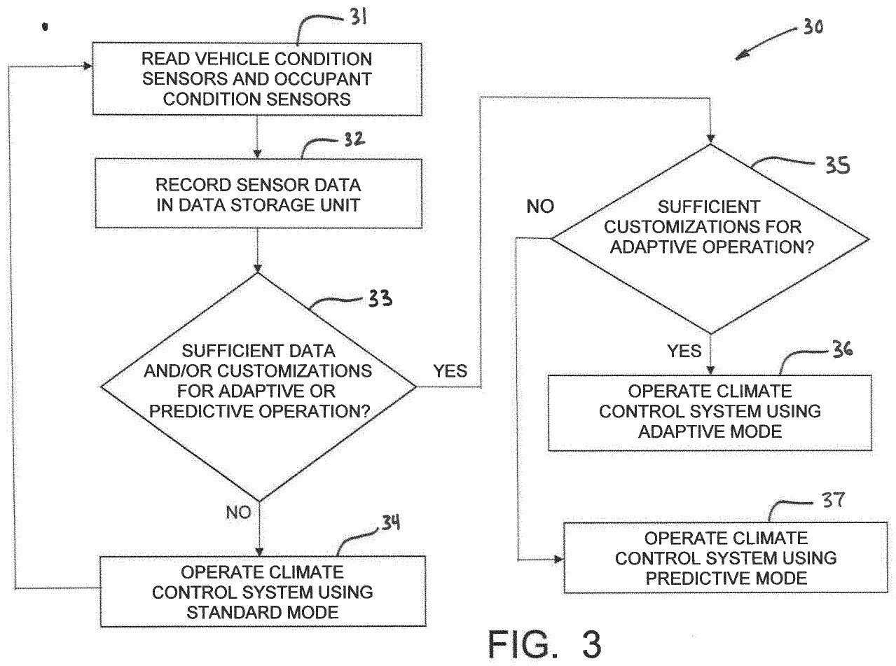

FIG. 3 is a flowchart that shows a method, indicated generally at 30, of operating the climate control system 20 illustrated in FIGS. 1 and 2 in accordance with this invention. The method 30 includes an initial instruction 31, wherein the controller 22 reads the signals from either or both of the vehicle condition sensors 23 and the occupant condition sensors 24. Then, the method 30 enters another instruction 32, wherein the signals and/or other data from either or both of the vehicle condition sensors 23 and the occupant condition sensors 24 are stored in the data storage unit 25. Next, the method 30 enters an initial decision point 33, wherein the controller 22 determines whether it is appropriate to operate the climate control system 20 in either a standard mode, an adaptive mode, or a predictive mode. This determination may, for example, be made by analyzing the data that has been received from either or both of the vehicle condition sensors 23 and the occupant condition sensors 24. Alternatively, this determination may be made by analyzing the number and magnitude of customizations that have been made by the occupant of the vehicle 10. However, this determination may be made in any other desired manner.

If the controller 22 determines in the initial decision point 33 that it is not appropriate to operate the climate control system 20 in either the adaptive mode or the predictive mode, then the method 30 branches from the decision point 33 to another instruction 34, wherein the controller 22 causes the HVAC system 21 of the vehicle 10 to operate in the standard mode. The characteristics of this standard mode of operation will be explained below. Thereafter, the method 30 returns to the initial instruction 31, wherein the controller 22 again reads the signals from either or both of the vehicle condition sensors 23 and the occupant condition sensors 24, and the method 30 is again further performed in the manner described above.

If, on the other hand, the controller 22 determines in the initial decision point 33 that it is appropriate to operate the climate control system 20 in either the adaptive mode or the predictive mode, then the method 30 branches from the initial decision point 33 to a second decision point 35, wherein the controller 22 determines whether it is appropriate to operate the climate control system 20 in the adaptive mode. If the controller 22 determines in the second decision point 35 that it is appropriate to operate the climate control system 20 in the adaptive mode, then the method 30 branches from the second decision point 35 to an instruction 36, wherein the controller 22 causes the HVAC system 21 of the vehicle 10 to operate in the adaptive mode. The characteristics of this adaptive mode of operation will be explained below. If, on the other hand, the controller 22 determines in the second decision point 35 that it is not appropriate to operate the climate control system 20 in the adaptive mode, then the method 30 branches from the second decision point 35 to an instruction 37, wherein the controller 22 causes the HVAC system 21 of the vehicle 10 to be operated in the predictive mode. The characteristics of this predictive mode of operation will also be explained below.

As mentioned above, the controller 22 is responsive to the signals from the vehicle condition sensors 23 and the occupant condition sensors 24 for generating signals to control the operation of the HVAC system 21 in accordance in either the standard mode, the adaptive mode, or the predictive mode. The standard mode of operation is conventional in the art and may be accomplished, for example, by regulating the heating, cooling, and/or ventilating effects generated by the HVAC system 21 in response to the operation of one or more manually operable control devices, such as push buttons and rotatable knobs, by the occupant of the vehicle seat. Alternatively, the HVAC system 21 may be automatically operated in accordance with standard thermal models such as, for example, those proposed by Fanger, Berkeley, and others.

The adaptive mode of operation is a control method by which the controller 22 alters the magnitudes of the heating, cooling, and/or ventilating effects generated by the HVAC system 21 in accordance with one or more of the signals and/or other data from either or both of the vehicle condition sensors 23 and the occupant condition sensors 24. For example, assume that the HVAC system 21 is initially operated by the occupant 11 of the vehicle seat 12 (using, for example, one or more of the push buttons and/or rotatable knobs mentioned above) to provide a predetermined amount of heating effects in accordance with the standard mode of operation. Then, after a period of time, assume that one of the vehicle condition sensors 23 detects that the temperature outside of the vehicle 10 has decreased significantly. In the adaptive mode of operation, the controller 22 will adaptively increase the magnitude of the heating effects generated by the HVAC system 21 automatically in response to the sensed decrease in the temperature outside of the vehicle 10. As a result, the thermal comfort provided by the HVAC system 21 to the occupant 11 of the vehicle seat 12 will be relatively constant notwithstanding changes in one or more of the signals and/or other data from either or both of the vehicle condition sensors 23 and the occupant condition sensors 24. Thus, the apparatus and method of this invention are adaptive in that as new data is collected from one or more of the signals and/or other data from either or both of the vehicle condition sensors 23 and the occupant condition sensors 24, it is provided to the controller 22, which automatically alters the operation of the HVAC system 21 to generate a preferred comfort trajectory for the occupant 11 of the vehicle 10.

The predictive mode of operation is a control method by which the controller 22 alters the magnitudes of the heating, cooling, and/or ventilating effects generated by the HVAC system 21 in accordance with calculated anticipated desires of the occupant 11 of the vehicle seat 12. The predictive mode of operation, which can be based entirely on basic statistical analysis, may be enabled when an image (or series of images) are sufficiently correlated to a reference image (or series of images). Alternatively, the predictive mode of operation may be enabled by using a match filter/batched matched filter scheme. This would apply when the reference image(s) is a previous thermal-imaging pattern/set of patterns associated with a specific occupant 11 of the vehicle seat 12. This reference image(s) can be sampled sufficiently to predict with an acceptable margin of error the trend gradient (input-output array of outcomes) based on thermal patterns and historical data (such as, for example, sixty-nine highly correlated images to produce a 90% confidence level with a 10% margin of error). A more complex machine learning structure could also be used to both identify the input patterns and predict thermal trends, as well as the effects of applied thermal changes. The main advantage of the predictive mode of operation is that it allows the current operation of the HVAC system 21 to be optimized, while optimizing the future operation thereof by anticipating future events and controlling the HVAC system 21 accordingly. Thus, the apparatus and method of this invention are also predictive in that the user comfort zones (and, therefore, times to targets) are updated as the system adjusts from generalized to user-specific mode (learning user inputs and adjustments, recognizing clothing conditions, etc.) that can further vary based on environmental conditions (such as season, ambient temperature, and the like).

The climate control system 20 can operate in adaptive mode without predictive inputs or in an adaptive mode with predictive inputs. However, the climate control system 20 is always adaptive if it is not being operated in accordance with the standard mode. The basic adaptive operation is based entirely on a real-time and prior historical subject and environmental sets of variables (such as use patterns, thermal camera patterns, cabin temp, etc.). The predictive adaptive mode can have a live thermo-physiological feedback from the thermal camera and the predictive model which continuously regulates environmental temperature controls in anticipation of thermal trends in order to reach and maintain a desirable thermal homeostasis most efficiently.

In summary, the controller 22 normally controls the operation of the HVAC system 21 to generate the heating, cooling, and/or ventilating effects in the standard mode of operation, wherein the heating, cooling, and/or ventilating effects are generated in response to the operation of one or more of the manually operable control devices. However, when a first amount of data has been received by the controller 22 from the sensors 23 and/or 24, the controller 22 controls the operation of the HVAC system 21 in the adaptive mode of operation, wherein the heating, cooling, and/or ventilating effects are generated in accordance with the data that is sensed or otherwise determined by the sensors 23 and/or 24. Furthermore, when a second amount of data has been received by the controller 22 from the sensors 23 and/or 24, the controller 22 controls the operation of the HVAC system 21 the predictive mode of operation, wherein the heating, cooling, and/or ventilating effects in accordance with calculated anticipated desires of the occupant.

The principle and mode of operation of this invention have been explained and illustrated in its preferred embodiment. However, it must be understood that this invention may be practiced otherwise than as specifically explained and illustrated without departing from its spirit or scope.

1. A climate control system comprising:
a sensor that is adapted to sense or otherwise determine data regarding an occupant of a seat;
an apparatus for generating heating, cooling, and/or ventilating effects in and/or around the seat; and
a controller that is responsive to the data from the sensor for controlling the operation of the apparatus for generating heating, cooling, and/or ventilating effects, wherein:
(1) the controller normally controls the operation of the apparatus for generating heating, cooling, and/or ventilating effects in a standard mode;
(2) when a first amount of data has been received by the controller from the sensor, the controller controls the operation of the apparatus for generating heating, cooling, and/or ventilating effects in an adaptive mode; and
(3) when a second amount of data has been received by the controller from the sensor, the controller controls the operation of the apparatus for generating heating, cooling, and/or ventilating effects in a predictive mode.

2. The climate control system defined in claim 1 wherein the sensor is an infrared image-based sensor.

3. The climate control system defined in claim 2 wherein the infrared image-based sensor is an infrared image-based camera.

4. The climate control system defined in claim 1 wherein the sensor is adapted to sense or otherwise determine data regarding one or more of identity, weight, body mass index, body surface area, stress level, physical exertion level, and thermal comfort zoning score of the occupant of the seat.

5. The climate control system defined in claim 1 wherein the sensor is a first sensor, and wherein the climate control system further includes a second sensor that is adapted to sense or otherwise determine data regarding a condition in and/or around a vehicle in which the seat is provided.

6. The climate control system defined in claim 5 wherein the sensor is adapted to sense or otherwise determine data regarding one or more of temperature outside of the vehicle, humidity outside of the vehicle, temperature inside of the vehicle, humidity inside of the vehicle, temperature of an engine within the vehicle, time of day, date or season, and geographic location of the vehicle.

7. The climate control system defined in claim 1 wherein the standard mode of operation is characterized by controlling the operation of the apparatus for generating heating, cooling, and/or ventilating effects in response to the operation of one or more manually operable control devices.

8. The climate control system defined in claim 7 wherein the adaptive mode of operation is characterized by controlling the operation of the apparatus for generating heating, cooling, and/or ventilating effects in accordance with the data that is sensed or otherwise determined by the sensor.

9. The climate control system defined in claim 8 wherein the predictive mode of operation is characterized by altering the operation of the apparatus for generating heating, cooling, and/or ventilating effects in accordance with calculated anticipated desires of the occupant.

10. The climate control system defined in claim 1 wherein:
the sensor is a first sensor, and wherein the climate control system further includes a second sensor that is adapted to sense or otherwise determine data regarding a condition in and/or around a vehicle in which the seat is provided;
the standard mode of operation is characterized by controlling the operation of the apparatus for generating heating, cooling, and/or ventilating effects in response to the operation of one or more manually operable control devices;
the adaptive mode of operation is characterized by controlling the operation of the apparatus for generating heating, cooling, and/or ventilating effects in accordance with the data that is sensed or otherwise determined by the sensor; and
the predictive mode of operation is characterized by altering the operation of the apparatus for generating heating, cooling, and/or ventilating effects in accordance with calculated anticipated desires of the occupant.

11. A method of operating a climate control system comprising:
(a) providing a sensor that is adapted to sense or otherwise determine data regarding an occupant of a seat;
(b) providing an apparatus for generating heating, cooling, and/or ventilating effects in and/or around the seat; and
(c) providing a controller that is responsive to the data from the sensor for controlling the operation of the apparatus for generating heating, cooling, and/or ventilating effects, wherein:
(1) the controller normally controls the operation of the apparatus for generating heating, cooling, and/or ventilating effects in a standard mode;
(2) when a first amount of data has been received by the controller from the sensor, the controller controls the operation of the apparatus for generating heating, cooling, and/or ventilating effects in an adaptive mode; and
(3) when a second amount of data has been received by the controller from the sensor, the controller controls the operation of the apparatus for generating heating, cooling, and/or ventilating effects in a predictive mode.

12. The method defined in claim 11 wherein the sensor is an infrared image-based sensor.

13. The method defined in claim 12 wherein the infrared image-based sensor is an infrared image-based camera.

14. The method defined in claim 11 wherein the sensor is adapted to sense or otherwise determine data regarding one or more of identity, weight, body mass index, body surface area, stress level, physical exertion level, and thermal comfort zoning score of the occupant of the seat.

15. The method defined in claim 11 wherein the sensor is a first sensor, and wherein the climate control system further includes a second sensor that is adapted to sense or otherwise determine data regarding a condition in and/or around a vehicle in which the seat is provided.

16. The method defined in claim 15 wherein the sensor is adapted to sense or otherwise determine data regarding one or more of temperature outside of the vehicle, humidity outside of the vehicle, temperature inside of the vehicle, humidity inside of the vehicle, temperature of an engine within the vehicle, time of day, date or season, and geographic location of the vehicle.

17. The method defined in claim 11 wherein the standard mode of operation is characterized by controlling the operation of the apparatus for generating heating, cooling, and/or ventilating effects in response to the operation of one or more manually operable control devices.

18. The method defined in claim 17 wherein the adaptive mode of operation is characterized by controlling the operation of the apparatus for generating heating, cooling, and/or ventilating effects in accordance with the data that is sensed or otherwise determined by the sensor.

19. The method defined in claim 18 wherein the predictive mode of operation is characterized by altering the operation of the apparatus for generating heating, cooling, and/or ventilating effects in accordance with calculated anticipated desires of the occupant.

20. The method defined in claim 11 wherein:
the sensor is a first sensor, and wherein the climate control system further includes a second sensor that is adapted to sense or otherwise determine data regarding a condition in and/or around a vehicle in which the seat is provided;
the standard mode of operation is characterized by controlling the operation of the apparatus for generating heating, cooling, and/or ventilating effects in response to the operation of one or more manually operable control devices;
the adaptive mode of operation is characterized by controlling the operation of the apparatus for generating heating, cooling, and/or ventilating effects in accordance with the data that is sensed or otherwise determined by the sensor; and
the predictive mode of operation is characterized by altering the operation of the apparatus for generating heating, cooling, and/or ventilating effects in accordance with calculated anticipated desires of the occupant.
